(19) United States
(12) Patent Application Publication
(10) Pub. No.: US 2021/0304647 A1
(43) Pub. Date: Sep. 30, 2021

(54) DEVICE AND SYSTEM FOR SECURING DECORATIVE ITEMS OR MESSAGES TO A CANDLE

(71) Applicant: Cakeless Candle, LLC, Palm Beach, FL (US)

(72) Inventors: Lori Bernstein, Palm Beach, FL (US); Yara Bashoor, Fort Lauderdale, FL (US)

(21) Appl. No.: 17/209,477

(22) Filed: Mar. 23, 2021

Related U.S. Application Data
(60) Provisional application No. 62/993,891, filed on Mar. 24, 2020.

(51) Int. Cl. G09F 23/00; G09F 1/10

(52) U.S. Cl. CPC G09F 23/00; G09F 1/10

(57) ABSTRACT

The present invention includes a device and system for providing or displaying a message, or other types of indicia, on a candle. The system may include individually, or in any combination, components which form magnetic connection using one or more permanent magnets, magnetically permeable materials, materials with magnetic properties, to align, self-align, attach, hold or release.

### RELATED APPLICATIONS

In accordance with 37 C.F.R. 1.76, a claim of priority is included in an Application Data Sheet filed concurrently herewith. Accordingly, the present invention claims priority to U.S. Provisional Patent Application No. 62/993,891, entitled “DEVICE AND SYSTEM FOR SECURING DECORATIVE ITEMS OR MESSAGES TO A CANDLE”, filed Mar. 24, 2020. The contents of the above referenced application are incorporated herein by reference in their entirety.

### FIELD OF THE INVENTION

The present invention generally relates to decorative or celebratory items; and more particularly, to a device and system for securing decorative items or celebratory messages to a candle.

### BACKGROUND OF THE INVENTION

Birthdays, as well as other celebrations in Western European countries, are often celebrated with cakes. Often times, such celebratory cakes are adorned with candles to celebrate age or other accomplishments. This tradition may date back to Roman times.

In classical Roman culture, cakes were occasionally served at special birthdays and at weddings. These were flat circles made from flour and nuts, leavened with yeast, and sweetened with honey. In the 15th century, bakeries in Germany began to market one-layer cakes for customer's birthdays, as opposed to only marketing cakes for weddings, and thus the modern birthday cake was born. During the 17th century, the birthday cake took on its contemporary form. These elaborate 17th century cakes had many aspects of the contemporary birthday cake, like multiple layers, icing, and decorations. However, these cakes were only available to the very wealthy. Birthday cakes became accessible to the lower class as a result of the industrial revolution and the spread of more materials and goods.

In contemporary Western cultures, the birthday cake is often decorated with small candles, secured with special holders or simply pressed down into the cake. In the UK, North America and Australia, the number of candles is equal to the age of the individual whose birthday it is, sometimes with one extra for luck.

While there are multiple theories that attempt to explain the origin of the birthday candle tradition, the actual origin is unknown. Through the years, the manner in which people gather to celebrate birthdays has changed. The celebrations are often held at restaurants where attendees celebrate with food and drink. In these gatherings, cake is not the focal point of the gathering. Instead, it is the fellowship of the group that takes precedence. In these gatherings, the participants still want to practice part of the old traditions. For example, the blowing out of a candle to grant a wish made by the birthday boy or girl. To accommodate this tradition, restaurants commonly serve a cup cake with a lit candle pushed into its center. The birthday participant makes a wish and blows out the candle.

While the use of one or multiple candles on a cake is a widely-accepted method for celebrating a birthday, such method may limit the celebratory message conveyed. That is, adding a candle to a cake or cupcake expresses the idea of a celebration, usually a birthday celebration. Adding multiple candles to the cake may also express how old a person is. However, other than alerting others a celebration is occurring or perhaps the age of the celebrator, the message conveyed by placing candles on a cake is limited.

What is needed is a device and system which provides conveying a message in combination with use of candles. The present invention provides a device and system for providing or displaying a message, or other types of indicia, to a candle. The device and system of the present invention allows a user to easily, quickly and safely secure or remove a message to a candle, thus adding to the atmosphere of the celebration.

### SUMMARY OF THE INVENTION

The present invention includes a device and system for providing or displaying a message, or other types of indicia, on a candle. The system may include individually, or in any combination, components which form magnetic connection using one or more permanent magnets, magnetically permeable materials, materials with magnetic properties, to align, self-align, attach, hold or release.

Accordingly, it is an objective of the invention to provide a device and system for providing or displaying a message, or other types of indicia, on a candle.

It is a still further objective of the present invention to provide a device and system using magnets for providing or displaying a message, or other types of indicia, on a candle.

It is a further objective of the invention to provide a candle for displaying a message.

It is a still further objective of the invention to provide a candle which uses magnets for displaying a message.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE FIGURES

FIG. 1 is a perspective view of an illustrative embodiment of a candle message display system;

FIG. 2 illustrates the candle message display system with the message display unit removed;

FIG. 3 illustrates an embodiment of a magnetic candle, shown with an embedded magnet;

FIG. 4 illustrates an embodiment of a magnetic candle, shown with an embedded rod or bar having magnetic properties;

FIG. 5 illustrates an embodiment of a magnetic candle, shown with an embedded spring having magnetic properties;

FIG. 6 illustrates an embodiment of a magnetic candle, shown with an embedded wire having magnetic properties;

FIG. 7 is a front view of the message display unit;

FIG. 8 is a back view of the message display unit;

FIG. 9 illustrates the message display unit shown with a combination of images and text or words; illustrated herein to include the message of “Happy 30th Birthday” and the images of confetti and balloons; and

FIG. 10 illustrates the message display unit shown with an image, illustrated herein as a birthday cake with candles.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

Referring to FIG. 1, a system for providing or displaying a message on a candle, referred to generally as the candle message display system 10, is illustrated. The candle message display system 10 includes one or more components, in any combination, including a magnetic candle 12 and a message display unit 14. The message display unit 14 is configured to be quickly and easily attached or removed from the magnetic candle 12. Referring to FIG. 2, the magnetic candle 12 is shown with the message display unit 14 removed. The magnetic candle 12 includes a top portion 16 with tip 17 and an exposed, embedded candle wick 18, a bottom portion 20 with a bottom surface 22, and a main body 24 separating the top portion 16 and the bottom portion 20. The candle 12 is generally constructed from a solid flammable material having a candle wick 18 embedded and extending the length of the solid flammable material. The solid flammable material is preferably wax or paraffin. However, other solid flammable materials such as tallow may be utilized without departing from the scope of the invention. The solid material is generally selected to become partially liquefied in the area of the flame to allow the flame to draw the flammable material through or along the wick to be vaporized and burned to maintain the flame so long as the solid remains. Embedded or disposed within the main body 24 is a message display securing member, illustrated herein as a magnet 26; see FIG. 3. The message display securing member may be embedded or disposed anywhere within the main body 24, such as in the center or closer to the outer surface 25 of the magnetic candle in order to function. Preferably, the message display securing member may be embedded or disposed closer to the outer surface 25 than to the center of the magnetic candle 12. The magnet 26 may be a permanent magnet, such as Neodymium iron boron magnets (neodymium) (NdFeB), Samarium cobalt magnets (SmCo), Alnico magnets, ceramic magnets, ferrite magnets, or temporary magnets. Alternatively, the message display securing member may be a ferromagnetic material, whereby a magnet may be attracted and secured to the member.

FIG. 4 illustrates the main body 24 with an embedded pin or rod 28. The embedded pin, rod or coil 28 may be magnetic or have ferromagnetic properties, have magnetic permeability, or be made of a material that forms a temporary magnet, so as to form a magnetic connection to align, auto-align, attach, hold or release.

FIG. 5 illustrates the main body 24 with an embedded spring 30. The embedded spring 30 may be magnetic or have magnetic properties, or be made of a material that forms a temporary magnet, so as to form a magnetic connection to align, auto-align, attach, hold or release.

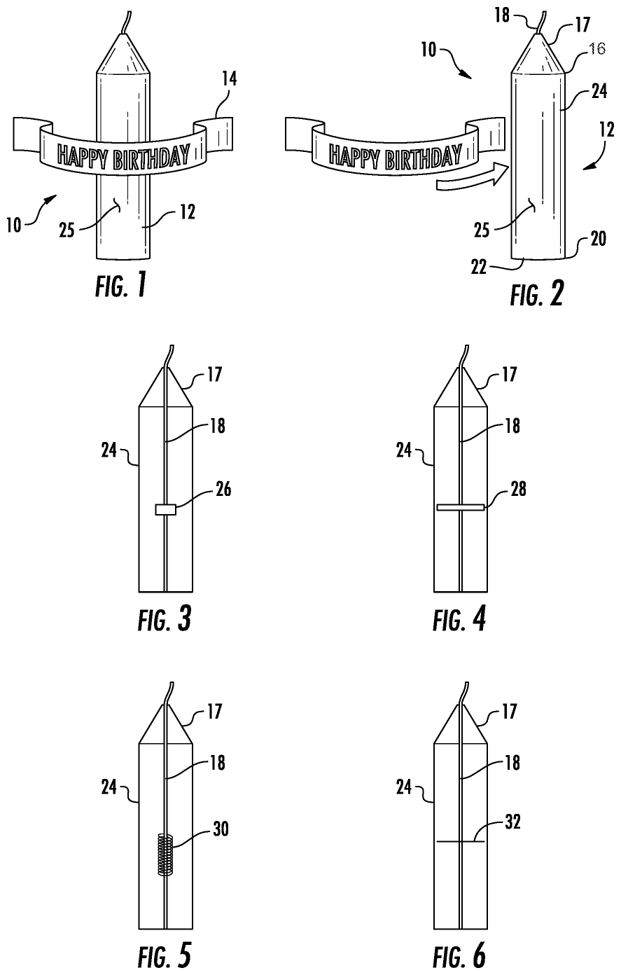

FIG. 6 illustrates the main body 24 with an embedded wire 32. The embedded wire 32 may be magnetic or have magnetic properties, or be made of a material that forms a temporary magnet, so as to form a magnetic connection to align, auto-align, attach, hold or release.

Referring to FIGS. 7-8, the message display unit 14 is shown with a text message 34 of “Happy Birthday” on the outer surface 36 (the surface that faces or is visible to a user when the message display unit 14 is secured to the magnetic candle 12) of the display unit body 38. While the message display unit 14 is shown in the shape of a banner, such is illustrative only. Accordingly, the message display unit 14 may have any shape or size. While the message display unit 14 may display text, other types of indicia, such as letters, numbers, symbols, pictures, colors, that convey a message or represent images to be communicated, alone or in combination, may be used.

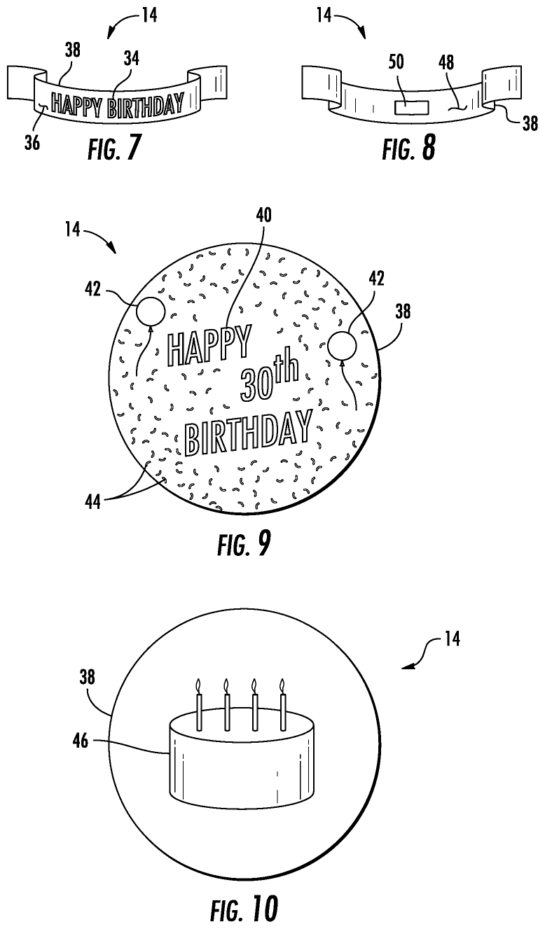

FIGS. 9-10 illustrate the message display unit 14 having a round or circular shaped display unit body 38. The display unit body 38 illustrated in FIG. 9 includes mixed indicia of text 40, having the words and numbers, “Happy 30th Birthday” in combination with a picture image of balloons 42 and confetti 44, thus conveying a message related to a birthday celebration. The display unit body 38 illustrated in FIG. 10 includes a picture image of a birthday cake 46, thus conveying a different message related to a birthday celebration.

Regardless of the message conveyed, the message display unit 14 is configured to be secured to or removed from the magnetic candle 12. Accordingly, the inner surface 48 (the surface that faces the magnetic candle 12 when attached there to) of the message display unit 14 is configured to secure to the magnetic candle securing member 50, such as the magnet 26, bar or rod 28, spring 30, or wire 32. Accordingly, secured to the inner surface 48 is a magnetic candle securing member 50. The magnetic candle securing member 50 may be any device or material that can secure to the message display securing member 50, and may include a magnet 26, such as a permanent magnet, such as Neodymium iron boron magnets (neodymium) (NdFeB), Samarium cobalt magnets (SmCo), Alnico magnets, ceramic magnets, ferrite magnets, temporary magnets, or a material that has magnetic properties or magnetic permeability, so as to form a magnetic connection to align, auto-align, attach, hold or release. Preferably, when a user places the inner surface 48 of the message display unit 14 at or near the message display securing member 50 of the magnetic candle 12, they are drawn together and secure to each other with sufficient force to remain together, or connected, until a sufficient second force is applied, or removed, to break the connection.

Any patents and publications mentioned in this specification are indicative of the levels of those skilled in the art to which the invention pertains.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A system for displaying a message on a candle comprising:
a candle constructed from a solid flammable material, a wick embedded and extending the length of the solid flammable material, the candle containing at least one ferromagnetic member suspended within the solid flammable material,
a message display unit, the message display unit having a first side and a second side, the first side including indicia to convey a message, the second side including a magnet member, the magnet member having a sufficiently strong magnetic field to support the message member when secured to the ferromagnetic member suspended within the solid flammable material.

2. The system for displaying a message on a candle of claim 1 wherein the solid flammable material is constructed and arranged to melt when the wick is lit by flame, the melted liquid drawn at least partially upwards through the wick, a portion of the liquid in the wick vaporized to maintain the flame.

3. The system for displaying a message on a candle of claim 2 wherein the ferromagnetic member is a rod containing iron.

4. The system for displaying a message on a candle of claim 2 wherein the ferromagnetic member is a coil containing iron.

5. The system for displaying a message on a candle of claim 2, wherein the ferromagnetic member is a magnet.

6. The system for displaying a message on a candle of claim 5, wherein the magnet is a permanent magnet.

7. The system for displaying a message on a candle of claim 5, wherein the permanent magnet is a Neodymium magnet.

8. The system for displaying a message on a candle of claim 6 wherein the permanent magnet is arranged with a north and south magnetic pole to orient the message display unit when secured to the candle.

9. The system for displaying a message on a candle of claim 2 wherein the ferromagnetic member is positioned just below an outer surface of the candle.

10. The system for displaying a message on a candle of claim 2 wherein the ferromagnetic member protrudes through an outer surface of the candle.

11. The system for displaying a message on a candle of claim 4 wherein the coil is positioned around the wick, whereby the message display unit may be secured at a desired position around the perimeter of the candle.
